(19) United States
(12) Patent Application Publication
(10) Pub. No.: US 2005/0222989 A1
(43) Pub. Date: Oct. 6, 2005

(54) Results based personalization of advertisements in a search engine

(76) Inventors: Taher Haveliwala, Mountain View, CA (US); Glen M. Jeh, San Francisco, CA (US); Sepandar D. Kamvar, San Francisco, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/877,775

(22) Filed: Jun. 24, 2004

Related U.S. Application Data
(63) Continuation-in-part of application No. 10/676,711, filed on Sep. 30, 2003.

(51) Int. Cl. G06F 7/00

(52) U.S. Cl. 707/3

(57) ABSTRACT

Personalized advertisements are provided to a user using a search engine to obtain documents relevant to a search query. The advertisements are personalized in response to a search profile that is derived from personalized search results. The search results are personalized based on a user profile of the user providing the query. The user profile describes interests of the user, and can be derived from a variety of sources, including prior search queries, prior search results, expressed interests, demographic, geographic, psychographic, and activity information.

### CROSS REFERENCE TO RELATED APPLICATIONS

This application is a continuation in part of U.S. application Ser. No. 10/676,711, entitled “PERSONALIZATION OF WEB SEARCH”. This application is also related to U.S. application Ser. No. 10/314,427, entitled “METHOD AND APPARATUS FOR SERVING RELEVANT ADVERTISEMENTS” (herein, “Relevant Advertisements Application”), to U.S. application Ser. No. 10/676,571, entitled “METHOD AND APPARATUS FOR CHARACTERIZING DOCUMENTS BASED ON CLUSTERS OF RELATED WORDS,” (herein, “Clusters of Related Words Application”), and to U.S. application Ser. No. 10/646,331, entitled “IMPROVED METHODS FOR RANKING NODES IN LARGE DIRECTED GRAPHS,” (herein “Ranking Nodes Application”). All of the above-identified applications are commonly owned with the instant application, and are incorporated by reference herein.

### FIELD OF INVENTION

This invention relates in general to providing advertisements to users of online search engines.

### BACKGROUND OF INVENTION

The current state of the art in online search engines is highly advanced in its ability to retrieve documents that are responsive to the terms of a query. The infeasibility of charging users for each search has lead search engine providers to rely on revenue from advertisers in order to fund the search services. Advertisements have historically been placed on various parts of the search engine interface, including as banner ads, and paid inclusion links, and sidebar ads. These advertisements are typically selected in response to the particular terms of the user's query. The underlying assumption of this model is that the query terms reflect the user's interests, and thus selecting advertisements based on the query terms should yield advertisements for products or services the match these interests. Of course, advertisers generally desire to provide ads to those users who would be interested in their products or services. Thus, if the user's query is “MP3 players”, then the assumption is that the user is interested in learning about, and potentially purchasing an MP3 player, and hence an advertisement for a particular MP3 player may result in the user's purchase. The current state of the art for such advertisements is the use of pay-for-performance advertisements, in which the advertiser pays the search engine provider for placement of the advertisement on the search results page only if the user selects (clicks on or activates) the advertisement.

The problem with query driven advertisements is in the underlying assumption that the current query best expresses the user's interests. This assumption is made because the query is the only information that the search engine has about the user, and thus the only basis on which to determine the user's interests. However, a query is only a very transient and unreliable indicator of a user's underlying interests. A user may search for all manner of information, and much of the time this may be for business, technical, scientific or other information entirely unrelated to the user's actual personal interests, which the advertiser is typically trying to reach.

Thus, there is a need for a mechanism by which search engine providers can target advertisements on their search engines the personal interests of a user.

### SUMMARY OF THE INVENTION

An advertisement serving system and methodology provides advertisements that are personalized to the interests of user in conjunction with the search results. Generally, the methodology includes selecting a set of documents responsive to a user query and a user profile containing user interest information, and then selecting one or more advertisements in response to a search profile derived from the set of documents. Because the set of documents are response to both the user query and to the user profile, they are thus personalized to the user's interests. The advertisements that are selected are also personalized because they are selected in response to a search profile derived from these personalized documents.

More specifically, in one embodiment, a user provides a search query to the system to search for documents relevant to the query. The system obtains a profile of the user that expresses the interests of the user. The user's interests may be expressed as terms, categories, or links, or any combination thereof. The user profile information is derived from any of prior searches by the user, prior search results, user activities in interacting with prior search results, user demographic, geographic, or psychographic information, expressed topic or category preferences, and web-sites associated with the user. The system executes the search query to obtain a set of relevant documents, and then uses the user profile to personalize the documents by reranking the documents in a manner that reflects their relevance to the user's profile. The personalized search results are then analyzed to further determine a search profile, such as key words or topics that are descriptive of the documents therein. The search profile is used to select one or more advertisements, which advertisements will thus be relevant to the user's interests. The selected advertisements and the personalized search results are combined and provided to the user.

In one aspect, a system in accordance with the present invention includes a search engine that processes a user's query to provide the search results, a personalization server that personalizes the search results based on the user's profile, a content analysis module that analyses the personalized search results to derive a search profile, and an advertisement server that selects one or more advertisements in response to the search profile.

The invention also has embodiments in computer program products, systems, user interfaces, and computer implemented methods for facilitating the described functions and behaviors.

### BRIEF DESCRIPTION OF THE DRAWINGS

FIG. 1 is a block diagram of system for providing results based personalized advertisements in accordance with one embodiment of the invention.

FIG. 2 illustrates multiple sources of user information and their relationship to a user profile.

FIG. 3 is an exemplary data structure that may be used for storing term-based profiles for a plurality of users.

FIG. 4A is an exemplary category map that may be used for classifying a user's past search experience.

FIG. 4B is an exemplary data structure that may be used for storing category-based profiles for a plurality of users.

FIG. 5 is an exemplary data structure that may be used for storing link-based profiles for a plurality of users.

FIG. 6 is a flowchart illustrating paragraph sampling.

FIG. 7A is a flowchart illustrating context analysis.

FIG. 7B depicts a process of identifying important terms using context analysis.

FIG. 8 illustrates a plurality of exemplary data structures that may be used for storing information about documents after term-based, category-based and/or link-based analyses, respectively.

FIG. 9A is a flowchart illustrating a personalized web search process according to one embodiment.

FIG. 9B is a flowchart illustrating a personalized web search process according to another embodiment.

The figures depict various embodiments of the present invention for purposes of illustration only. One skilled in the art will readily recognize from the following discussion that alternative embodiments of the illustrated and described structures, methods, and functions may be employed without departing from the principles of the invention.

### DETAILED DESCRIPTION

System Overview

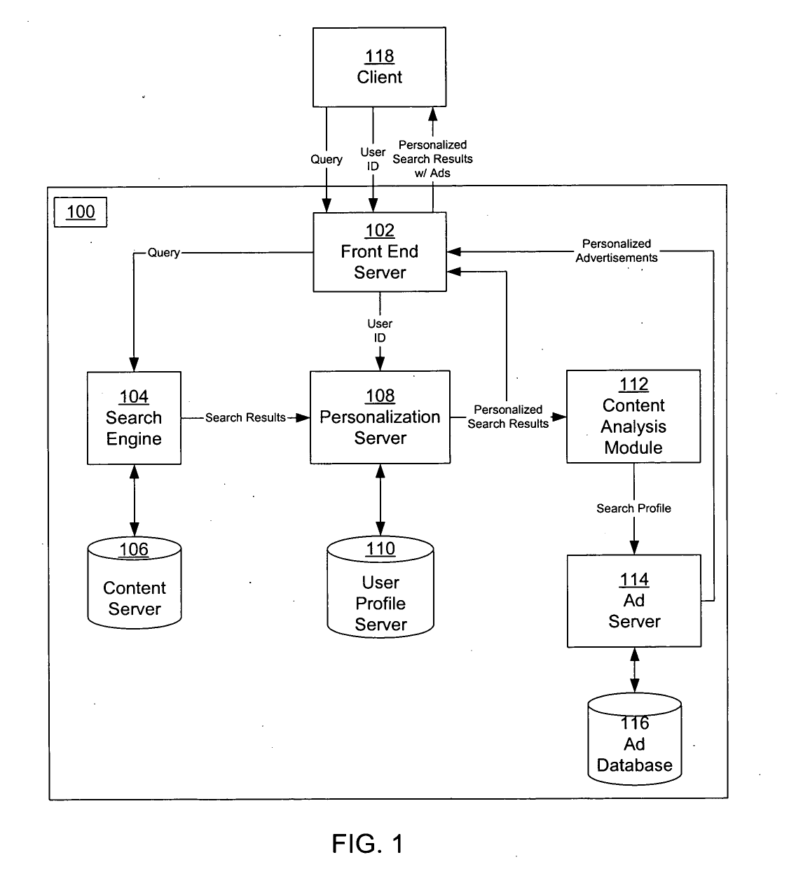

FIG. 1 illustrates a system 100 in accordance with one embodiment of the present invention. System 100 comprises a front-end server 102, a search engine 104 and associated content server 106, a personalization server 108 and associated user profile server 110, a content analysis module 112, an advertisement server 114 and associated advertisement database 116. During operation, a user accesses the system 100 via a conventional client 118 over a network (such as the Internet, not shown) operating on any type of client computing device, for example, executing a browser application. While only a single client 118 is shown, the system 100 supports large number of concurrent sessions with many clients. The system 100 operates on high performance server class computers; similarly the client device 118 can be any type of computing device. The details of the hardware aspects of server and client computers is well known to those of skill in the art and thus is not further described here.

The front-end server 102 is responsible for receiving a search query submitted by the client 119 along with some form of user ID that identifies either the user herself or the client device 118. The front-end server 102 provides the query to the search engine 104, which evaluates the query to retrieve a set of search results in accordance with the search query and returning the results to the front-end server 102. The search engine 104 communicates with one or more content servers 106 and one or more user profile servers 108. A content server 106 stores a large number of indexed documents indexed (and/or retrieved) from different websites. Alternately, or in addition, the content server 106 stores an index of documents stored on various websites. “Documents” are understood here to be any form of indexable content, including textual documents in any text or graphics format, images, video, audio, multimedia, presentations, and so forth. In one embodiment, each indexed document is assigned a rank or score using a link-based scoring function that takes into account an attribute associated with one or more links to the document. One example of a link-based scoring function is the page rank of a document. The page rank serves as a query independent measure of the document's importance. An exemplary form of page rank is described in U.S. Pat. No. 6,285,999 which is incorporated by reference. The search engine 104 communicates with one or more of the content servers 106 to select a plurality of documents that are relevant to user's search query. The search engine 104 assigns a score to each document based on the document's page rank, the text associated with the document, and the search query.

The personalization server 108 receives the search results from the search engine 104, and the user ID from the front-end server 102, and personalizes the results based on a profile of the user. The personalization server 108 communicates with the user profile server 110, which stores a plurality of user profiles in a user profile database 110. Each user profile includes information that identifies a user as well as describes the user's interests which can be used to refine the search results in response to the search queries submitted by this user. A user profile can be derived from a variety of different sources, such as the user's previous search experience, personal information, web pages associated with the user, and so forth. One embodiment for constructing the user's profile and using it to personalize search results is further described in the next section.

More specifically, the user profile server 108 receives the user ID from the front-end server 102, and returns the associated profile to the personalization server 108. The personalization server 108 personalizes the search results by rescoring and/or reranking the documents included there according to the user profile. The personalization server 108 provides the personalized search results back to the front-end server 102.

The personalization server 108 also provides the personalized search results to the content analysis module 112. The content analysis module 112 analyzes the content of the documents included in the search results (or a subset thereof), and derives a search profile that is descriptive of the documents. For example, the search profile can comprise key terms in the documents, topics or categories that describe the documents, website information from which the documents were retrieved, and so forth. Because the search profile is derived from the personalized search results, it reflects the personalization of the results, and thus the descriptive information preserves this personalization aspect.

The content analysis module 112 provides the search profile to the advertisement server 114. The advertisement server 114 uses the search profile to select from the advertisement database 116 one or more advertisements for displaying in conjunction with the personalized search results. The selected personalized advertisements are provided to the front-end server 102.

The front-end server 102 receives the personalized search results and the personalized advertisements, and combines them (or a subset of each) to form a web page (results page) having some number of the documents from the search results and some number of the advertisements. This results page is returned to the client 118, where its rendered and displayed to the user, typically in the window of a browser or similar application (depending on client device). The personalized advertisements can be displayed next to the search result lists in a side panel, in a separate frame of the window, or in any other graphical format deemed appropriate.

The next sections describe the construction and use of user profiles to personalize search results, and the construction and use of the search profiles to personalize advertisement.

Creation and Maintenance of User Profiles

A user profile describes the user's interests in a manner that can be used to personalize the results of any particular search query. The user profile can be derived from information that is explicitly provide by the user (e.g., designation of interests or topics in a directory), or information that is inferred from the user's behaviors and interactions with the search engine 104, or information that is inferred from the user's online relationships (e.g., websites or pages associated with the user's IP address).

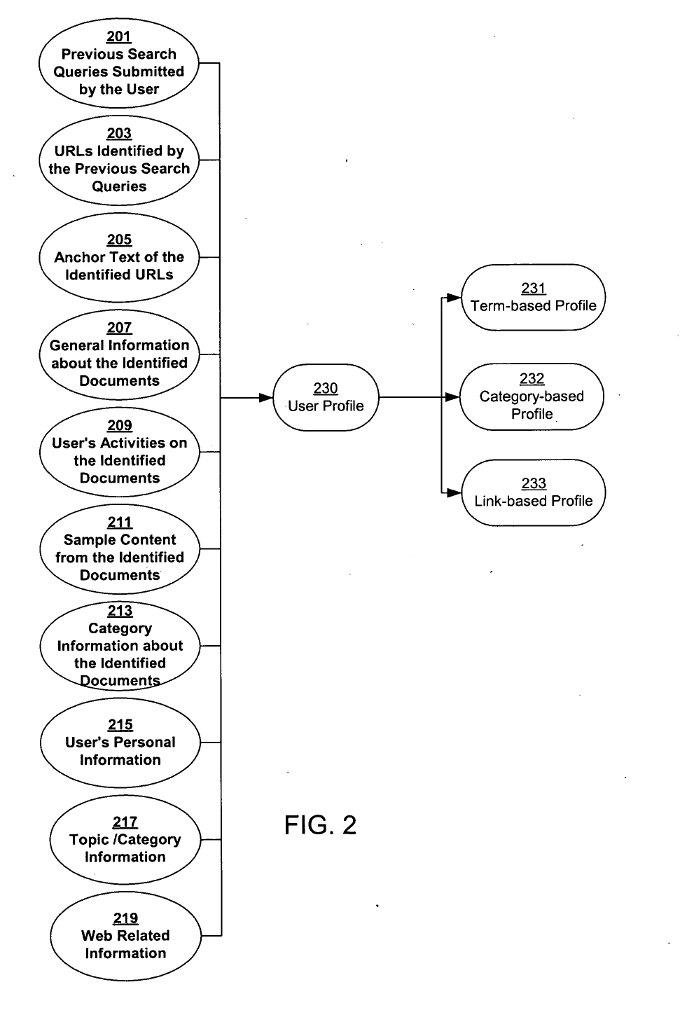

With respect to information derived from the user's interaction with the search engine 104, prior search activities (both search queries themselves, and user access or non-access to the results) provide useful hints about the user's interests. FIG. 2 provides an overview of various sources of information that are beneficial for user profile construction. For example, previously submitted search queries 201 are very helpful in profiling a user's interests. If a user has submitted multiple search queries related to diabetes, it is more likely than not that this is a topic of interest to the user. If the user subsequently submits a query including the term “organic food”, it can be reasonably inferred that he may be more interested in those organic foods that are helpful in fighting diabetes. Similarly, the universal resource locators (URL) 203 associated with the search results in response to the previous search queries and their corresponding anchor texts 205, especially for search result items that have been selected or “visited” by the user (e.g., downloaded or otherwise viewed by the user), are helpful in determining the user's preferences. When a first page contains a link to a second page, and the link has text associated with it (e.g., text neighboring the link), the text associated with the link is called “anchor text” with respect to the second page. Anchor text establishes a relationship between the text associated with a URL link in a document and another document to which the URL link points. The advantages of anchor text include that it often provides an accurate description of the document to which the URL link points, and it can be used to index documents that cannot be indexed by a text-based search engine, such as images or databases. In addition, a count may be maintained for each URL that is associated with the user's search results, and URLs receiving high counts are identified or otherwise analyzed in the user profile.

After receiving search results, the user may click on some of the URL links, thereby downloading the documents referenced by those links, so as to learn more details about those documents. Certain types of general information 207 can be associated with a set of user selected or use identified documents. For purposes of forming a user profile, the identified documents from which information is derived for inclusion in the user profile may include: documents identified by search results from the search engine, documents accessed (e.g., viewed or downloaded, for example using a browser application) by the user (including documents not identified in prior search results), documents linked to the documents identified by search results from the search engine, and documents linked to the documents accessed by the user, or any subset of such documents.

The general information 207 about the identified documents is also useful information about the user's preferences and interests. General information includes information such as the document format of accessed documents (e.g., HTML, plain text, portable document format (PDF), Microsoft Word), date information, creator information, and other metadata.

Activity information 209 describes the user's activities with respect to the user selected documents (sometimes herein called the identified documents). This information describes factors such as how long the user spent viewing the document, the amount of scrolling activity on the document, and whether the user has printed, saved or bookmarked the document, and thus also suggests the importance of the document to the user as well as the user's preferences. In some embodiments, information about user activities 209 is used when weighting the importance of information extracted or derived from the user identified documents. In some embodiments, information about user activities 209 is used to determine which of the user identified documents to use as the basis for deriving the user profile. For example, information 209 may be used to select only documents that received significant user activity (in accordance with predefined criteria) for generating the user profile, or information 209 may be used to exclude from the profiling process documents that the user viewed for less than a predefined threshold amount of time.

The content of identified documents from previous search activities is a rich source of information about a user's interests and preferences. Key terms appearing in the identified documents and their frequencies with which they appear in the identified documents are not only useful for indexing the document, but are also a strong indication of the user's personal interests, especially when they are reinforce other types of user information discussed above. In one embodiment, instead of the whole documents, sampled content 211 from the identified documents is extracted for the purpose of user profile construction, to save storage space and computational cost. In another embodiment, various information related to the identified documents may be classified to constitute category information 213 about the identified documents. More discussion about content sampling, the process of identifying key terms in an identified document and the usage of the category information is provided below.

Optionally, a user may choose to offer personal information 215, including demographic and geographic information associated with the user, such as the user's age or age range, educational level or range, income level or range, language preferences, marital status, geographic location (e.g., the city, state and country in which the user resides, and possibly also including additional information such as street address, zip code, and telephone area code), cultural background or preferences, or any subset of these. Alternatively, the geographic information can be inferred, for example, from the user's IP address, without having the user provide the geographic information explicitly. In particular, generally, one can map an IP address to an organization. If the organization is in one place (i.e. Stanford), then it is possible to infer the graphical location of the user searching from that IP address. The personal information 215 may also indicate whether the user is a member of in one or more defined groups (e.g., organizations, companies, associations, clubs, committees, and the like). The personal information 215 may also include psychographic information (e.g., personality trait information, or other personality descriptive information) either derived from other aspects of the user profile, or expressly provided by the user.

Compared with other types of personal information such as a user's favorite sports or movies that are often time varying, this personal information is more static and more difficult to infer from the user's search queries and search results, but maybe crucial in correctly interpreting certain queries submitted by the user. For example, if a user submits a query containing “Japanese restaurant”, it is very likely that he may be searching for a local Japanese restaurant for dinner. Without knowing the user's geographical location, it is hard to order the search results so as to bring to the top those items that are most relevant to the user's true intention. In certain cases, however, it is possible to infer this information. For example, users often select results associated with a specific region corresponding to where they live.

Another potential source of information are expressed topics or category preferences 217. The user profile can include a list of terms or topics that the user expressly indicates as being among the user's interests. The terms can be selected by the user from a predefined list or hierarchy of topics and terms, or provided by the entirely by the user. Each term or topic can be associated with a weight indicating a degree of importance to the user.

Another potential source of information for the user profile is information 219 derived from web pages and web sites associated with the user. First, a given user often accesses the system 100 from a relatively limited number of IP addresses and domains. The system 100 can automatically identify and access one or more websites associated with these IP addresses and extract information from them, such as their type (commercial, educational, organization, government, etc.), their geographic location, their size, and so forth. The system can further perform analyses of one or more of the pages on these sites (such as the home page), to extract relevant topics, key words, or other descriptive information.

Creating a user profile 230 from the various sources of user information is a multi-step process, which be divided into sub-processes. Each sub-process produces one type of user profile characterizing a user's interests or preferences from a particular perspective. They are:
a term-based profile 231—this profile represents a user's search preferences with a plurality of terms, where each term is given a weight indicating the importance of the term to the user;
a category-based profile 233—this profile correlates a user's search preferences with a set of categories, which may be organized in a hierarchal fashion, with each category being given a weight indicating the extent of correlation between the user's search preferences and the category; and
a link-based profile 235—this profile identifies a plurality of links that are directly or indirectly related to the user's search preferences, with each link being given a weight indicating the relevance between the user's search preferences and the link.

In some embodiments, the user profile 230 includes only a subset of these profiles 231, 233, 235, for example just one or two of these profiles. In one embodiment, the user profile 230 includes a term-based profile 231 and a category-based profile 233, but not a link-based profile 235.

In one embodiment, a user profile is created and stored on a server (e.g., user profile server 108) associated with a search engine. The advantage of such deployment is that the user profile can be easily accessed by multiple computers, and that since the profile is stored on a server associated with (or part of) the search engine 104, it can be easily used by the search engine 104 to personalize the search results. In another embodiment, the user profile can be created and stored on the user's client 118. Creating and storing a user profile on the client not only reduces the computational and storage cost for the search engine's servers, but also satisfies some users' privacy requirements. In yet another embodiment, the user profile may be created and updated on the client 118, but stored in the user profile server 110. Such embodiment combines some of the benefits illustrated in the other two embodiments. It is understood by a person of ordinary skill in the art that the user profiles of the present invention can be implemented using client computers, server computers, or both.

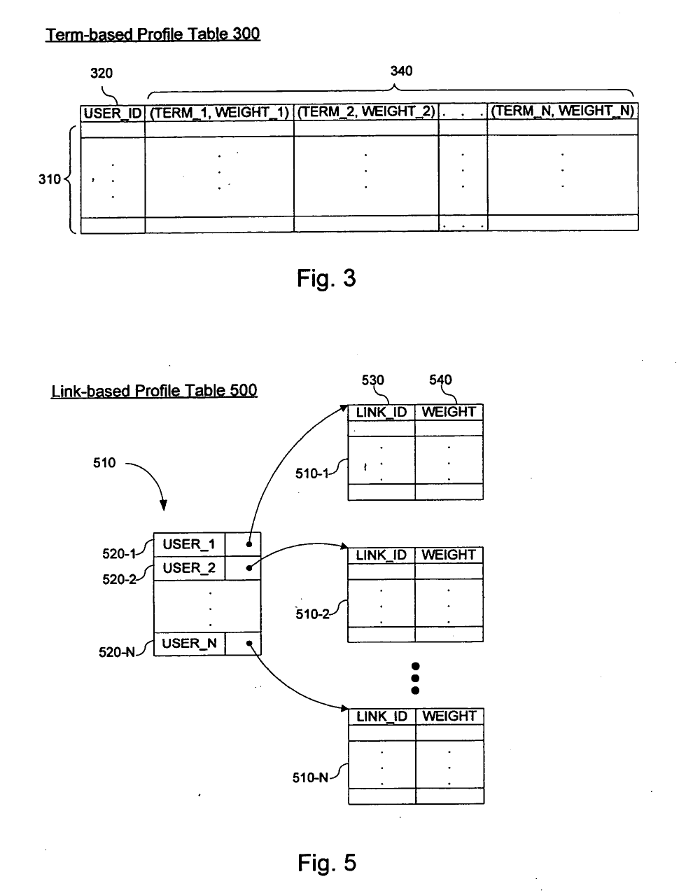

FIG. 3 illustrates an exemplary data structure, a term-based profile table 300, that may be used for storing term-based profiles for a plurality of users. Table 300 includes a plurality of records 310, each record corresponding to a user's term-based profile. A term-based profile record 310 includes a plurality of columns including a USER_ID column 320 and multiple columns of (TERM, WEIGHT) pairs 340. The USER_ID column stores a value that uniquely identifies a user, which may be the USER_ID itself, or a hash thereof. For a given user, there is a set of (TERM, WEIGHT) pairs, where each (TERM, WEIGHT) pair 340 includes a term, typically 1-3 words long, that is usually important to the user, and a weight associated with the term that quantifies the importance of the term. In one embodiment, the term may be represented as one or more n-grams. An n-gram is defined as a sequence of n tokens, where the tokens may be words. For example, the phrase “search engine” is an n-gram of length 2, and the word “search” is an n-gram of length 1. A particular USER_ID may also be used to identify a group of users.

N-grams can be used to represent textual objects as vectors. This makes it possible to apply geometric, statistical and other mathematical techniques, which are well defined for vectors, but not for objects in general. In the present invention, n-grams can be used to define a similarity measure between two terms based on the application of a mathematical function to the vector representations of the terms.

The weight of a term is not necessarily a positive value. If a term has a negative weight, it may suggest that the user prefers that his search results should not include this term and the magnitude of the negative weight indicates the strength of the user's preference for avoiding this term in the search results. By way of example, for a user who is breeds Australian Shepard dogs in San Francisco, Calif., the term-based profile may include terms like “Australian Shepard”, “agility training” and “San Francisco” with positive weights. The terms like “German Shepard” or “Australia” may also be included in the profile. However, these terms are more likely to receive a negative weight since they are irrelevant and confusing with the authentic preference of this particular user.

A term-based profile itemizes a user's preference using specific terms, each term having certain weight. If a document contains a term that is in a user's term-based profile, the term's weight will be assigned to the document; however, if a document does not contain the term, it will not receive any weight associated with this term. Such a requirement of relevance between a document and a user profile sometimes may be less flexible when dealing with various scenarios in which a fuzzy relevance between a user's preference and a document exists. For example, if a user's term-based profile includes terms like “Mozilla” and “browser”, a document containing no such terms, but other terms like “Galeon” or “Opera” will not receive any weight because they do not match any existing term in the profile, even though they are actually Internet browsers. To address the need for matching a user's interests without exact term matching, a user's profile may include a category-based profile.

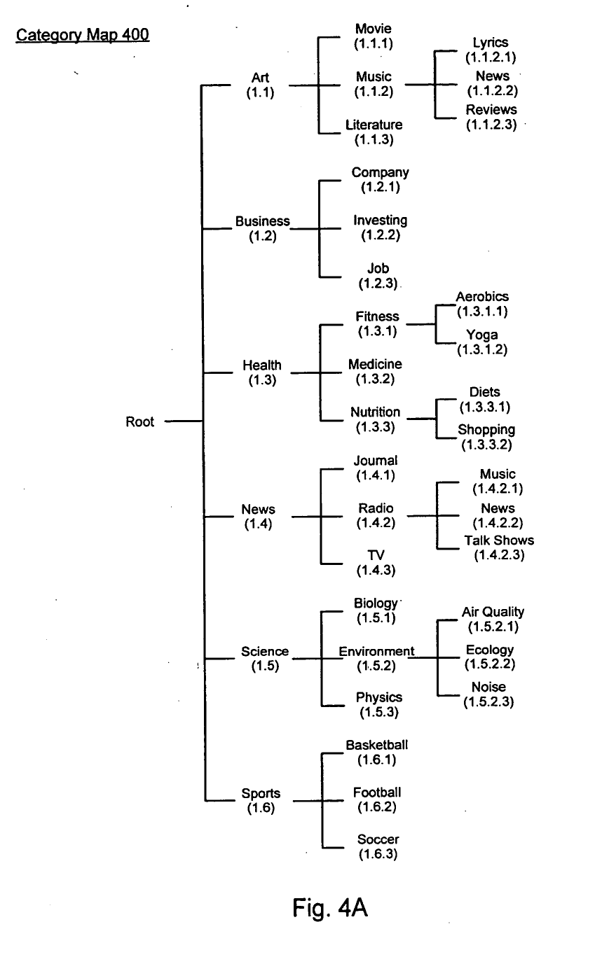

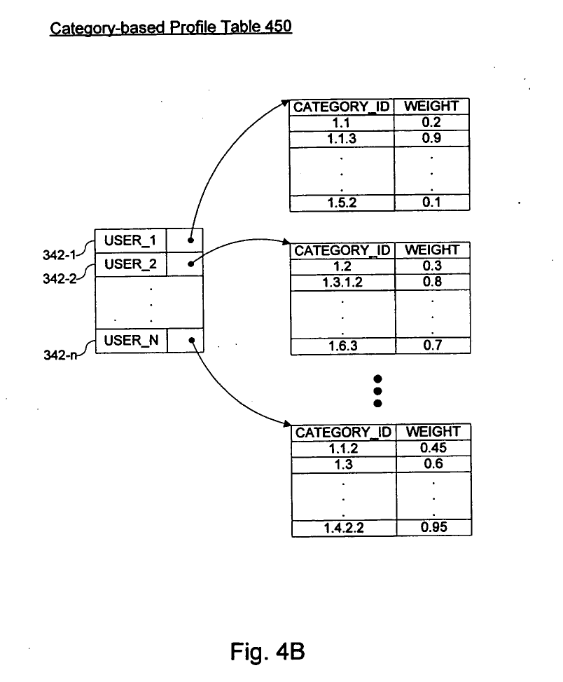

FIG. 4A illustrates a hierarchical category map 400 according to the Open Directory Project (http://dmoz.org/). Starting from the root level of map 400, documents are organized under several major topics, such as “Art”, “News”, “Sports”, etc. These major topics are often too broad to delineate a user's specific interest. Therefore, they are further divided into sub-topics that are more specific. For example, topic “Art” may comprise sub-topics like “Movie”, “Music” and “Literature” and the sub-topic “Music” may further comprise sub-sub-topics like “Lyrics”, “News” and “Reviews”. Note that each topic is associated with a unique CATEGORY_ID like 1.1 for “Art”, 1.4.2.3 for “Talk Show” and 1.6.1 for “Basketball”.

A user's specific interests may be associated with multiple categories at various levels, each of which may have a weight indicating the degree of relevance between the category and the user's interest. In one embodiment, a category-based profile may be implemented using a hash table data structure as shown in FIG. 4B. A category-based profile table 450 includes a table 455 that comprises a plurality of records 460, each record including a USER_ID and a pointer pointing to another data structure, such as table 460-1. Table 460-1 may include two columns, CATEGORY_ID column 470 and WEIGHT column 480. CATEGORY_ID column 470 contains a category's identification number as shown in FIG. 4A, suggesting that this category is relevant to the user's interests and the value in the WEIGHT column 480 indicates the degree of relevance of the category to the user's interests.

A user profile based upon the category map 400 is a topic-oriented implementation. The items in a category-based profile can also be organized in other ways. In one embodiment, a user's preference can be categorized based on the formats of the documents identified by the user, such as HTML, plain text, PDF, Microsoft Word, etc. Different formats may have different weights. In another embodiment, a user's preference can be categorized according to the types of the identified documents, e.g., an organization's homepage, a person's homepage, a research paper, or a news group posting, each type having an associated weight. Another type category that can be used to characterize a user's search preferences is document origin, for instance the country associated with each document's host. These types of category information can be derived from either the user's prior searches 203, or from the user's web related information 217. In yet another embodiment, the above-identified category-based profiles may co-exist, with each one reflecting one aspect of a user's preferences.

Besides term-based and category-based profiles, another type of user profile is referred to as a link-based profile. As discussed above, a page rank algorithm, such as disclosed in U.S. Pat. No. 6,285,999 uses the link structure that connects various documents over the Internet. A document that has more links pointing to it is often assigned a higher page rank and therefore attracts more attention from a search engine. Link information related to a document identified by a user can also be used to infer the user's preferences. In one embodiment, a list of preferred URLs are identified for a user by analyzing the frequency of his access to those URLs. Each preferred URL may be further weighted according to the time spent by the user and the user's scrolling activity at the URL, and/or other user activities 209 when visiting the document at the URL. In another embodiment, a list of preferred hosts are identified for a user by analyzing the user's frequency of accessing web pages of different hosts. When two preferred URLs are related to the same host the weights of the two URLs may be combined to determine a weight for the host. In another embodiment, a list of preferred domains are identified for a user by analyzing the user's frequency of accessing web pages of different domains. For example, for finance.yahoo.com, the host is “finance.yahoo.com” while the domain is “yahoo.com”.

FIG. 5 illustrates a link-based profile using a hash table data structure. A link-based profile table 500 includes a table 510 that includes a plurality of records 520, each record including a USER_ID and a pointer pointing to another data structure, such as table 510-1. Table 510-1 may include two columns, LINK_ID column 530 and WEIGHT column 540. The identification number stored in the LINK_ID column 530 may be associated with a preferred URL or host. The actual URL/host/domain may be stored in the table instead of the LINK_ID, however it is preferable to store the LINK_ID to save storage space.

A preferred list of URLs and/or hosts includes URLs and/or hosts that have been directly identified by the user. The preferred list of URLs and/or host may furthermore extend to URLs and/or hosts indirectly identified by using methods such as collaborative filtering or bibliometric analysis, which are known to persons of ordinary skill in the art. In one embodiment, the indirectly identified URLs and/or host include URLs or hosts that have links to/from the directly identified URLs and/or hosts. These indirectly identified URLs and/or hosts are weighted by the distance between them and the associated URLs or hosts that are directly identified by the user. For example, when a directly identified URL or host has a weight of 1, URLs or hosts that are one link away may have a weight of 0.5, URLs or hosts that are two links away may have a weight of 0.25, etc. This procedure can be further refined by reducing the weight of links that are not related to the topic of the original URL or host, e.g., links to copyright pages or web browser software that can be used to view the documents associated with the user selected URL or host. Irrelevant Links can be identified based on their context or their distribution. For example, copyright links often use specific terms (e.g., copyright or “All rights reserved” are commonly used terms in the anchor text of a copyright link); and links to a website from many unrelated websites may suggest that this website is not topically related (e.g., links to the Internet Explorer website are often included in unrelated websites). The indirect links can also be classified according to a set of topics and links with very different topics may be excluded or be assigned a low weight. Various methods of bibliometric analysis are further described in the Ranking Nodes Application, referenced above.

The three types of user profiles discussed above are generally complimentary to one another since different profiles delineate a user's interests and preferences from different vantage points. However, this does not mean that one type of user profile, e.g., category-based profile, is incapable of playing a role that is typically played by another type of user profile. By way of example, a preferred URL or host in a link-based profile is often associated with a specific topic, e.g., finance.yahoo.com is a URL focusing on financial news. Therefore, what is achieved by a link-based profile that comprises a list of preferred URLs or hosts to characterize a user's preference may also be achievable, at least in part, by a category-based profile that has a set of categories that cover the same topics covered by preferred URLs or hosts.

The generation of a term-based profile 231 is generally as follows. Given a document identified (e.g., viewed) by a user, different terms in the document may have different importance in revealing the topic of the document. Some terms, e.g., the document's title, may be extremely important, while other terms may have little importance. For example, many documents contain navigational links, copyright statements, disclaimers and other text that may not be related to the topic of the document. How to efficiently select appropriate documents, content from those documents and terms from within the content is a challenging topic in computational linguistics. Additionally, it is preferred to minimize the volume of user information processed, so as make the process of user profile construction computationally efficient. Skipping less important terms in a document helps in accurately matching a document with a user's interest.

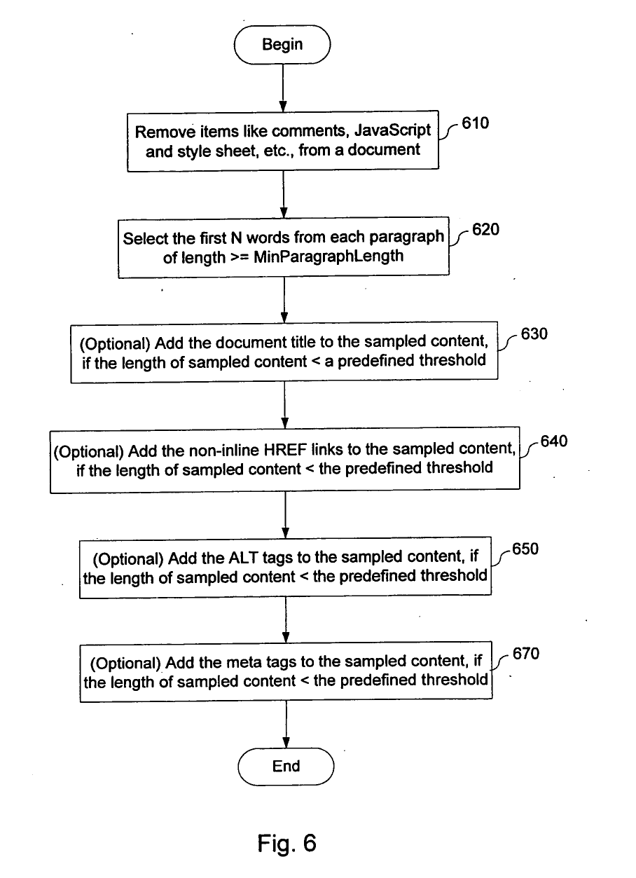

Paragraph sampling (described below with reference to FIG. 6) is a procedure for automatically extracting content from a document that may be relevant to a user. The paragraph sampling process takes advantage of the insight that less relevant content in a document, such as navigational links, copyright statements, disclaimer, etc., tends to from relatively short segments of text. In one embodiment, paragraph sampling looks for the paragraphs of greatest length in a document, processing the paragraphs in order of decreasing length until the length of a paragraph is below a predefined threshold. The paragraph sampling procedure optionally selects up to a certain maximum amount of content from each processed paragraph. If few paragraphs of suitable length are found in a document, the procedure falls back to extracting text from other parts of the document, such as anchor text and ALT tags.

FIG. 6 is a flowchart illustrating the major steps of paragraph sampling. The process assumes that the document is initially loaded the document into memory. Paragraph sampling includes removing 610 (or simply ignoring) certain predefined items, such as comments, JavaScript and style sheets, etc., from a document. These items are removed because they are usually related to visual aspects of the document when rendered on a browser and are unlikely to be relevant to the document's topic. Following that, the procedure selects 620 the first N words (or M sentences) from each paragraph whose length is greater than a threshold value, MinParagraphLength, as sampled content. In one embodiment, the values of N and M are chosen to be 100 and 5, respectively. Other values may be used in other embodiments.

In order to reduce the computational and storage load associated with the paragraph sampling procedure, the procedure may impose a maximum limit, e.g., 1000 words, on the sampled content from each document. In one embodiment, the paragraph sampling procedure organizes all the paragraphs in a document in length decreasing order, and then starts the sampling process with a paragraph of maximum length. It is noted that the beginning and end of a paragraph depend on the appearance of the paragraph in a browser, not on the presence of uninterrupted a text string in the HTML representation of the paragraph. For this reason, certain HTML commands, such as commands for inline links and for bold text, are ignored when determining paragraph boundaries. In some embodiments, the paragraph sampling procedure screens the first N words (or M sentences) so as to filter out those sentences including boilerplate terms like “Terms of Service” or “Best viewed”, because such sentences are usually deemed irrelevant to the document's topic.

Before sampling a next paragraph whose length is above the threshold value, the procedure may check to determine if the number of words in the sampled content has reached a maximum word limit. If so, the process can stop sampling content from the document. If the maximum word limit has not been reached after processing all paragraphs of length greater than the threshold, optional steps 630, 640, 650 and 670 are performed. In particular, the procedure adds the document title (630), the non-inline HREF links (640), the ALT tags (650) and the meta tags (670) to the sampled content until it reaches the maximum word limit.

Once a document has been sampled, the sampled content can be used for identifying a list of most important (or unimportant) terms through context analysis. Context analysis attempts to learn context terms that predict the most important (or unimportant) terms in a set of identified documents. Specifically, it looks for prefix patterns, postfix patterns, and a combination of both. For example, an expression “x's home page” may identify the term “x” as an important term for a user and therefore the postfix pattern “* home page” can be used to predict the location of an important term in a document, where the asterisk “*” represents any term that fits this postfix pattern. In general, the patterns identified by context analysis usually consist of m terms before an important (or unimportant) term and n terms after the important (or unimportant) term, where both m and n are greater than or equal to 0 and at least one of them is greater than 0. Typically, m and n are less than 5, and when non-zero are preferably between 1 and 3. Depending on its appearance frequency, a pattern may have an associated weight that indicates how important (or unimportant) the term recognized bay the pattern is expected to be.

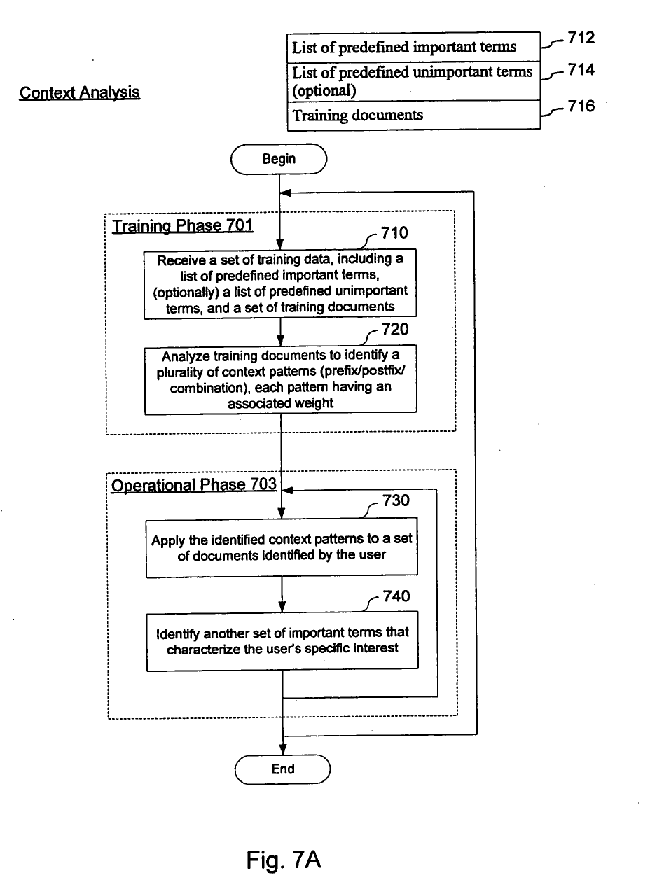

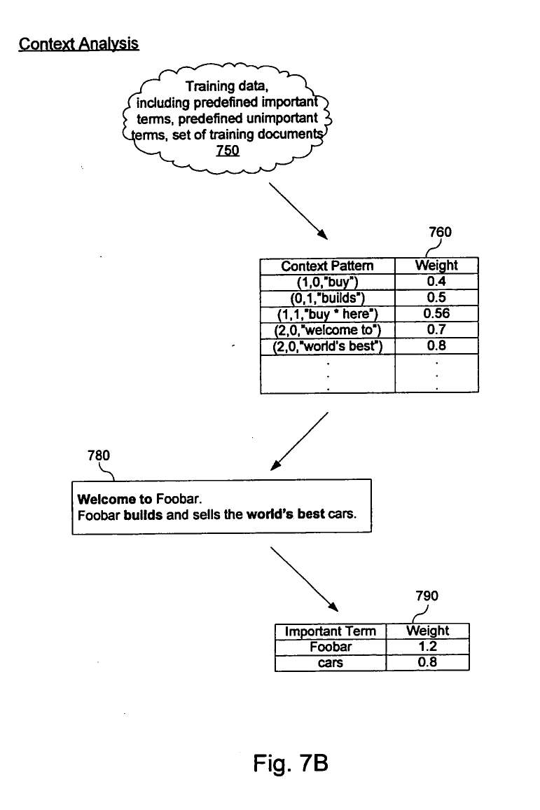

FIG. 7A illustrates a flowchart for one embodiment of context analysis. This embodiment has two distinct phases, a training phase 701 and an operational phase 703. The training phase 701 receives 710 and utilizes a list of important terms 712, an optional list of unimportant terms 714, and a set of training documents. In some embodiments, the list of unimportant terms is not used. The source of the lists 712, 714 is not critical. In some embodiments, these lists 712, 714 are generated by extracting words or terms from a set of documents (e.g., a set of several thousand web pages of high page rank) in accordance with a set of rules, and then editing them to remove terms that in the opinion of the editor do not belong in the lists. The source of the training documents is also not critical. In some embodiments, the training documents comprise a randomly or pseudo-randomly selected set of documents already known to the search engine. In other embodiments, the training documents are selected from a database of documents in the search engine in accordance with predefined criteria.

During the training phase 701, the training documents are processed 720, using the lists of predefined important and unimportant terms, so as to identify a plurality of context patterns (e.g., prefix patterns, postfix patterns, and prefix-postfix patterns) and to associate a weight with each identified context pattern. During the operational phase 703, the context patterns are applied 730 to a document to identify 740 a set of important terms that characterize the user's specific interests and preferences. This process is repeated for any number of documents that are deemed to be associated with the user. Learning and delineating a user's interests and preferences is usually an ongoing process. Therefore, the operational phase 703 may be repeated to update the set of important terms that have been captured previously. This may be done each time a user accesses a document, according to a predetermined schedule, at times determined in accordance with specified criteria, or otherwise from time to time. Similarly, the training phase 701 may also be repeated to discover new sets of context patterns and to recalibrate the weights associated with the identified context patterns.

Below is a segment of pseudo code that exemplifies the training phase:

```
For each document in a set {
    For each important term in the document {
      For m = 0 to MaxPrefix {
        For n = 0 to MaxPostfix {
          Extract the m words before the important term and the n
          words after the important term as s;
          Add 1 to ImportantContext(m,n,s);
        }
      }
    }
    For each unimportant term in the document {
      For m = 0 to MaxPrefix {
        For n = 0 to MaxPostfix {
          Extract the m words before the unimportant term and the n
          words after the unimportant term as s;
          Add 1 to UnimportantContext(m,n,s);
        }
      }
    }
}
For m = 0 to MaxPrefix {
    For n = 0 to MaxPostfix {
      For each value of s {
        Set the weight for s to a function of ImportantContext(m,n,s),
        and UnimportantContext(m,n,s);
      }
    }
}
```

In the pseudo code above, the expression s refers to a prefix pattern (n=0), a postfix pattern (m=0) or a combination of both (m>0 & n>0). Each occurrence of a specific pattern is registered at one of the two multi-dimensional arrays, ImportantContext(m,n,s) or UnimportantContext(m,n,s). The weight of a prefix, postfix or combination pattern is set higher if this pattern identifies more important terms and fewer unimportant terms and vice versa. Note that it is possible that a same pattern may be associated with both important and unimportant terms. For example, the postfix expression “* operating system” may be used in the training documents 716 in conjunction with terms in the list of predefined important terms 712 and also used in conjunction with terms in the list of predefined unimportant terms 714. In this situation, the weight associated with the postfix pattern “* operating system” (represented by the expression Weight(1,0, “operating system”)) will take into account the number of times the postfix expression is used in conjunction with terms in the list of predefined important terms as well as the number of times the postfix expression is used in conjunction with terms in the list of predefined unimportant terms. One possible formula to determine the weight of a context patterns is:
Weight(m,n,s)=Log(ImportantContext(m,n,s)+1)−Log(UnimportantContext(m,n,s)+1).
Other weight determination formulas may be used in other embodiments.

In the second, operational phase 703 of the context analysis process, the weighted context patterns are used to identify important terms in one or more documents identified by the user. Referring to FIG. 7B, in the first phase the personalization server 108 receives training data 750 and creates a set of context patterns 760, each context pattern having an associated weight. The personalization server 108 then applies the set of context patterns 760 to a document 780. In FIG. 7B, previously identified context patterns found within the document 780 are identified. Terms 790 associated with the context patterns are identified and each such term receives a weight based on the weights associated with the context patterns. For example, the term “Foobar” appears in the document twice, in association with two different patterns, the prefix pattern “Welcome to *” and the postfix pattern “* builds”, and the weight 1.2 assigned to “Foobar” is the sum of the two patterns' weights, 0.7 and 0.5. The other identified term “cars” has a weight of 0.8 because the matching prefix pattern “world's best *” has a weight of 0.8. In some embodiments the weight for each term is computed using a log transform, where the final weight is equal to log(initial weight +1). It is possible that the two terms “Foobar” and “cars” may not be in the training data 750 and may have never been encountered by the user before. Nevertheless, the context analysis method described above identifies these terms and adds them to the user's term-based profile. Thus, context analysis can be used to discover terms associated with a particular documents, where the documents are those associated with the user, and thus the user's interests and preferences.

As noted, the output of context analysis can be used directly in constructing a user's term-based profile. Additionally, it may be useful in building other types of user profiles, such as a user's category-based profile. For example, a set of weighted terms can be analyzed and classified into a plurality of categories covering different topics, and those categories can be added to a user's category-based profile.

After executing the context analysis on a set of documents identified by or for a user, the resulting set of terms and weights may occupy a larger amount of storage than allocated for each user's term-based profile. Also, the set of terms and corresponding weights may include some terms with weights much, much smaller than other terms within the set. Therefore, in some embodiments, at the conclusion of the context analysis, the set of terms and weights is pruned by removing terms having the lowest weights (A) so that the total amount of storage occupied by the term-based profile meets predefined limits, and/or (B) so as to remove terms whose weights are so low, or terms that correspond to older items, as defined by predefined criteria, that the terms are deemed to be not indicative of the user's search preferences and interests. In some embodiments, similar pruning criteria and techniques are also applied to the category-based profile and/or the link-based profile.

In some embodiments, a user's profile is updated in the above manner each time the user performs a search and selects at least one document from the search results to download or view. In some embodiments, the personalization server 108 builds a list of documents identified by the user (e.g., by selecting the documents from search results) over time, and at predefined times (e.g., when the list reaches a predefined length, or a predefined amount of time has elapsed), performs a profile update of the user profile. When performing an update, new profile data is generated, and the new profile data is merged with the previously generated profile data for the user. In some embodiments, the new profile data is assigned higher importance than the previously generated profile data, thereby enabling the system to quickly adjust a user's profile in accordance with changes in the user's search preferences and interests. For example, the weights of items in the previously generated profile data may be automatically scaled downward prior to merging with the new profile data. In one embodiment, there is a date associated with each item in the profile, and the information in the profile is weighted based on its age, with older items receiving a lower weight than when they were new. In other embodiments, the new profile data is not assigned high importance than the previously generated profile data.

The paragraph sampling and context analysis methods may be used independently or in combination. When used in combination, the output of the paragraph sampling is used as input to the context analysis method. When used alone, the context analysis method can take the entire text of a document as its input, rather than just a sample.

Personalization of Search Results with the User Profile

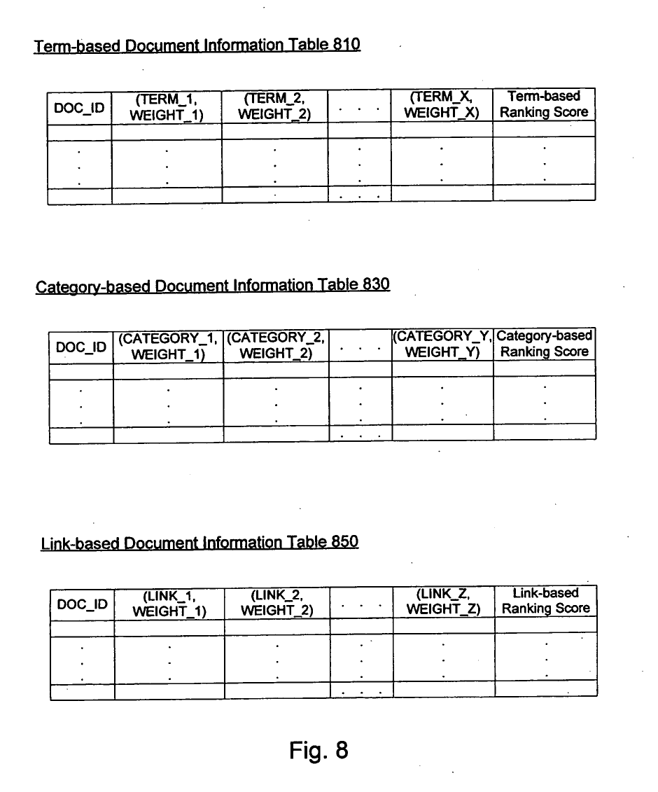

The above-described methods used for creating user profiles, e.g., paragraph sampling and context analysis, may be also leveraged for determining the relevance of a candidate document to a user's preference, and thereby personalizing the results of a given search. Indeed, one function of the system 100 is to identify a set of documents that are most relevant to a user's interests based on both the user's search query as well as the user's user profile. FIG. 8 illustrates several exemplary data structures that can be used to store information about a document's relevance to a user profile from multiple perspectives. As noted above, the search engine 104 retrieves a set of documents that form the search results. These documents are herein called “candidate documents”, since they are candidates that may be potentially provided to the user. For each candidate document, identified by a respective DOC_ID, term-based document information table 810 includes multiple pairs of terms and their weights, category-based document information table 830 includes a plurality of categories and associated weights, and link-based document information table 850 includes a set of links and corresponding weights.

The rightmost column of each of the three tables (810, 830 and 850) stores the rank (or a computed score) of a document when the document is evaluated using the particular type of user profile associated with the table. A user profile rank for a given document can be determined by combining the weights of the items (columns) associated with a document. For instance, a category-based or topic-based profile rank may be computed as follows. A user may prefer documents associated with the “Science” category with a weight of 0.6, while he dislikes documents about the “Business” category with a weight of −0.2. Thus, when a document that is within the “Science” category matches a search query, it will be weighted higher than a document in the “Business” category. In general, the document topic classification may not be exclusive. A candidate document may be classified as being a science document with probability of 0.8 and a business document with probability of 0.4. A link-based profile rank may be computed based on the relative weights allocated to a user's URL, host, domain, etc., preferences in the link-based profile. In one embodiment, term-based profile rank can be determined using known techniques, such as the term frequency-inverse document frequency (TF-IDF). The term frequency of a term is a function of the number of times the term appears in a document. The inverse document frequency is an inverse function of the number of documents in which the term appears within a collection of documents. For example, very common terms like “the” occur in many documents and consequently as assigned a relatively low inverse document frequency.

When a search engine generates search results in response to a search query, a candidate document D that satisfies the query is assigned a query score, QueryScore, in accordance with the search query. This query score is then modulated by document D's page rank, PageRank, to generate a generic score, GenericScore, that is expressed as
GenericScore=QueryScore*PageRank.

This generic score may not appropriately reflect document D's importance to a particular user U if the user's interests or preferences are dramatically different from that of the random surfer. The relevance of document D to user U can be accurately characterized by a set of profile ranks, based on the correlation between document D's content and user U's term-based profile, herein called the TermScore, the correlation between one or more categories associated with document D and user U's category-based profile, herein called the CategoryScore, and the correlation between the URL and/or host of document D and user U's link-based profile, herein called the LinkScore. Therefore, document D may be assigned a personalized rank that is a function of both the document's generic score and the user profile scores. In one embodiment, this personalized score can be expressed as:
PersonalizedScore=GenericScore*(TermScore+CategoryScore+LinkScore).

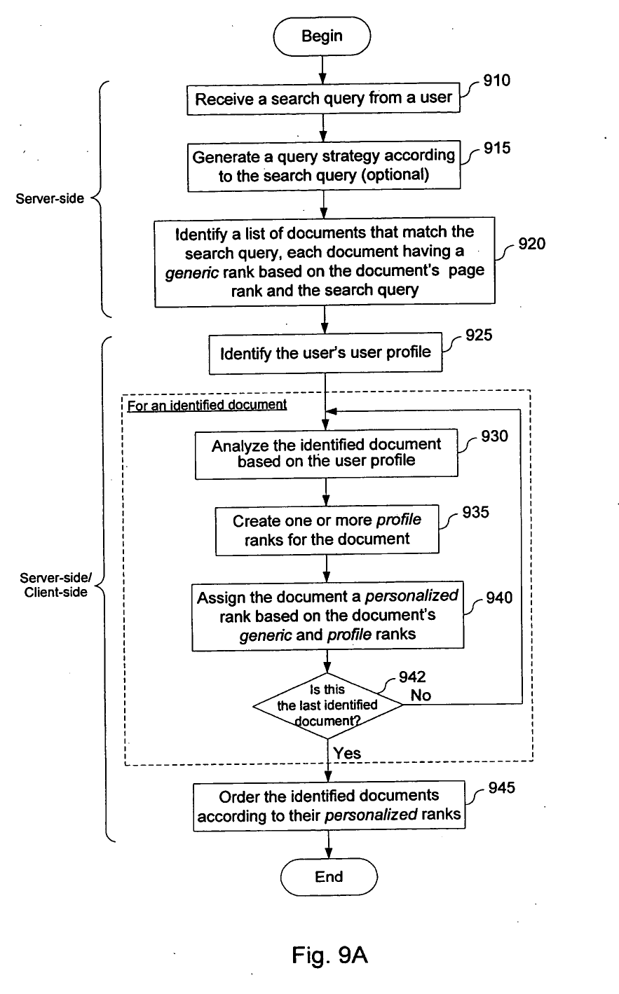

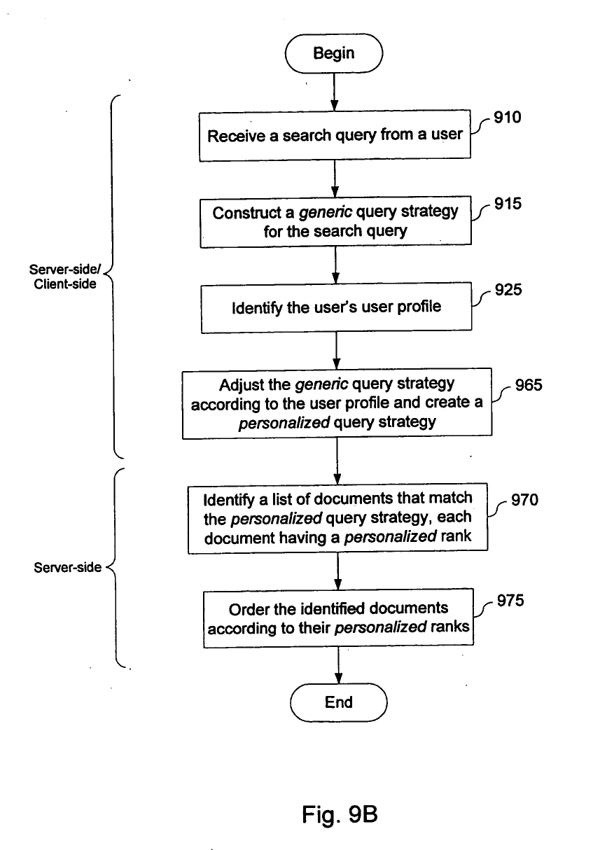

FIGS. 9A and 9B represent two embodiments, both implemented in a network environment such as the network environment shown in FIG. 1. In the embodiment shown in FIG. 9A, the search engine 104 receives 910 via the front-end server 102, a search query from the client 118 that is submitted by a particular user. In response, the search engine 104 may optionally generate 915 a query strategy (e.g., the search query is normalized so as to be in proper form for further processing, and/or the search query may be modified in accordance with predefined criteria so as to automatically broaden or narrow the scope of the search query). The search engine 104 submits 920 the search query (or the query strategy, if one is generated) to the content server 106. The content server 106 identifies a list of documents that match the search query, each document having a generic score that depends on the document's page rank and the search query. This set of documents is also referred to as the search results, and they are typically ordered based on their GenericScore. In general, all the three operations are conducted by the search engine 104 and content server 106, which is on the server side of the network. There are two options on where to implement the operations following these first three steps.

In some embodiments that employ a server-side implementation, the user's ID is embedded in the query string provided by the client 118. This ID is passed from the front-end server 102 to the personalization server 108. Based on the user's ID, the user profile server 110 identifies 925 the user's user profile 230. The personalization server 108 analyzes each document in the search results to determine its relevance to the user's profile, creates 935 a profile score for the identified document. The profile score is based on any or all of the parts of the user profile 230 and then assigns 940 the document a personalized score that is a function of the document's generic and profile score. The personalization server 108 checks whether the current document is the last one of the search results. If not, the personalization server 108 processes the next document in the search results. Otherwise, the search results are re-ordered 945 according to their personalized scores, to form the personalized search results. The personalized search results are provided to the front-end server 102 and to the content analysis module 112.

Embodiments using a client-side implementation are similar to the server-side implementation, except that after the search engine 104 obtains 920 the initial set of results, the search results sent to the corresponding client from whom the user submitted the query. This client stores the user's user profile 230 and it is responsible for re-ordering the documents based upon the user profile. In this embodiment, the client device has a local version of the personalization server 108, which performs essentially the same scoring and ranking functionality as previously described. Therefore, this client-side implementation may reduce the workload on the system 100. Further, since there is no privacy concern with the client-side implementation, a user may be more willing to provide private information to customize the search results. However, one limitation to the client-side implementation is that only a limited number of documents, e.g., the top 50 documents (as determined using the generic rank), may be sent to a client for reordering due to limited network bandwidth. In contrast, the server-side implementation may be able to apply a user's profile 230 to a much larger number of documents in the search result, e.g., 1000. Therefore, the client-side implementation may deprive a user access to those documents having relatively low generic ranks, but significantly personalized ranks.

FIG. 9B illustrates another embodiment. As before, the user's query and user ID is received via the front-end server 102, and the search engine 104 constructs 915 a generic query strategy. In addition, the search engine 104 adjusts 965 the generic query strategy according to the user's user profile 230 to create a personalized query strategy. This is done by the front-end server 102 providing the user's ID to the personalization server 108, which retrieves the user profile 230 and terms from the user's term profile 231. These terms are then added to the search query. The creation of the personalized query strategy can be performed either on the client side or on the server side of the system. This embodiment avoids the network bandwidth restriction facing the previous embodiment. The search engine 104 submits 970 the personalized query strategy to the content server 106. Since the content server 106 takes into account the additional personalized terms for the user's profile, the search results returned by the content server 106 have already been ordered 975 by the documents' personalized ranks.

The profiles 230 of a group of users with related interests may be combined together to form a group profile, or a single profile may be formed based on the documents identified by the users in the group. For instance, several family members may use the same computer to submit search queries to a search engine. If the computer is tagged with a single user identifier by the search engine, the “user” will be the entire family of users, and the user profile will be represent a combination or mixture of the search preferences of the various family members. An individual user in the group may optionally have a separate user profile that differentiates this user from other group members. In operation, the search results for a user in the group are ranked according to the group profile, or according to the group profile and the user's user profile when the user also has a separate user profile.

It is possible that a user may switch his interests so dramatically that his new interests and preferences bear little resemblance to his user profile, or a user may be temporarily interested in a new topic. In this case, personalized search results produced according to the embodiments depicted in FIGS. 9A and 9B may be less favorable than search results ranked in accordance with the generic ranks of the documents in the search results. Additionally, the search results provided to a user may not include new websites among the top listed documents because the user's profile tends to increase the weight of older websites that the user has visited (i.e., older websites from which the user has viewed or downloaded web pages) in the past.

To reduce the impact caused by a change in a user's preferences and interests, the personalized search results may be merged with the generic search results. In one embodiment, the generic search results and personalized search results are interleaved, with the odd positions (e.g., 1, 3, 5, etc.) of a search results list reserved for generic search results and the even positions (e.g., 2, 4, 6, etc.) reserved for personalized search results, or vice versa. Preferably, the items in the generic search results will not duplicate the items listed in the personalized search results, and vice versa. More generally, generic search results are intermixed or interleaved with personalized search results, so that the items in the search results presented to the user include both generic and personalized search results.

In another embodiment, the personalized ranks and generic ranks are further weighted by a user profile's confidence level. The confidence level takes into account factors such as how much information has been acquired about the user, how close the current search query matches the user's profile, how old the user profile is, etc. If only a very short history of the user is available, the user's profile may be assigned a correspondingly low confidence value. The final score of an identified document can be determined as:
FinalScore=ProfileScore*ProfileConfidence+GenericScore*(1−ProfileConfidence).
When intermixing generic and personalized results, the fraction of personalized results may be adjusted based on the profile confidence, for example using only one personalized result when the confidence is low.

Sometimes, multiple users may share a machine, e.g., in a public library. These users may have different interests and preferences. In one embodiment, a user may explicitly login to the service so the system knows his identity. Alternatively, different users can be automatically recognized based on the items they access or other characteristics of their access patterns. For example, different users may move the mouse in different ways, type differently, and use different applications and features of those applications. Based on a corpus of events on a client and/or server, it is possible to create a model for identifying users, and for then using that identification to select an appropriate “user” profile. In such circumstances, the “user” may actually be a group of people having somewhat similar computer usage patterns, interests and the like.

Personalization of Advertisements

Referring again to FIG. 1, the content analysis module 112 receives from the personalized search results from the personalization server 108, which then analyses the documents referenced therein, and provides a search profile to the advertisement server. The advertisement server 114 uses the search profile to select from the advertisement database 116 one or more advertisements for displaying in conjunction with the personalized search results.

The content analysis module 112 creates the search profile by determining key topic words or terms that are descriptive of the documents references in personalized search results as a group. Thus, for selected documents in the personalized search results, the content analysis module 112 determines a set of one or more topics, and then uses this set of topics to determine the topics descriptive of the personalized search results (e.g., selecting the N most frequently occurring topics, or some other filtering/selection process). The content analysis module 112 may apply any type of topic extraction methods known in the art or developed hereafter, as the particular algorithm used for topic extraction is not a limitation of the invention.

The content analysis module 112 can analyze of the documents in the personalized search results, or any subset thereof. In one embodiment, the personalized search results form a plurality of pages, each page containing some number of the documents. The documents that would be on the first page of results are the subset which the content analysis module 112 analyzes. This approach is beneficial since the documents on this first page are those most relevant to the user's interests, and hence the resulting search profile will likewise contain the most relevant terms and topics.

In one embodiment, the content analysis module 112 uses the methods described above with respect to FIGS. 6, and 7A-7B for constructing the term based profile of the user. Here, the operational goal is a set of terms that describe the topics of the personalized search results. In another embodiment, the content analysis module 112 uses a combination of internal document analysis that extracts topics based on the frequencies of key words in the document and in the entire document collection, and link analysis (based on the inbound and outbound link structure of each document). As a particular example of the latter, the content analysis module 112 can determine if a given document in the personalized search results is linked to one or more topics in topical directory (e.g., (http://dmoz.org/), and if so, uses these linked topics as candidate topics for the document. Further details of these types of methods are disclosed the Relevant Advertisements Application, cited above, which is incorporated by reference herein. In another embodiment, the content analysis module 112 uses a probabilistic model to determine the topics for inclusion in the search profile. One method of generation and use of a probabilistic model in this manner is described in the Clusters of Related Words Application, cited above, which is also incorporated by reference herein.

In any of these embodiments, the content analysis module 112 provides a search profile that includes a set of terms that describe the personalized search results, and may be characterized as the topics that the documents in the personalized search results are about. The search profile is provided to the advertisement server 114, which then selects one or more advertisements for inclusion with the personalized search results. The advertisement server 114 can select the advertisements in any number of ways including any known or hereafter developed method, and the present invention is not limited to any particular method for selecting advertisements given a set of terms or topics. One method of selection of relevant advertisements is described in the Relevant Advertisements Application, cited above. In general, the advertisement server 114 maintains a database of terms or topics, along with the advertisement database 116, which can also be indexed, either by keywords extracted from each advertisement, or with keywords selected by provider of the advertisement. The association of terms in the database to advertisement keywords can be by any number of mechanisms, including various types of monetary based models (e.g., pay-for-placement, pay-for-performance), or matching algorithms (e.g., Boolean match, or fuzzy matching). What is of interest in the advertisement selection process is that the advertisement server 114 selects advertisements using a search profile derived from the search results that were personalized based on the user's profile. Hence, the advertisements that are selected will in turn be personalized to the interests of the user.

Once selected, the advertisements are than provided to the front end server 102, along with the personalized search results. The front end server 102 integrates the selected personalized advertisements into the personalized search results, and provides the results to the client 118, for example as a web page, or through whatever other visualization or presentation interface the client 118 is using. The advertisements may be interlineated with the personalized search results, or placed in a visually segregated region of the user interface of the client (e.g., a separate window, pane, tab, or graphical demarcated area).

The advertisements provided to the front end server 102 can be integrated with the personalized search results so that they appear on every page of the results. In an alternative embodiment, a different set of advertisements is provided on each page of the personalized search results, where the advertisements are derived from a search profile that is responsive to just the documents listed on that page. Thus, in this embodiment, the content analysis module 112 updates the search profile in response to the user accessing another page of the personalized search results, and provides the updated search profile to the advertisement server 114, which selects the appropriate advertisements in response thereto.

In another embodiment, additional information is used to create the search profile. In particular, the results of both the personalized results of the current search query, and of at least one prior search query, are analyzed by the content analysis module 112 to form the search profile. This approach is beneficial to reflect a more long term assessment of the user's interests, as it spans multiple queries. This is beneficial because user's typically attempt multiple queries in a given area of interest, rather than just a single query.

In some instances, the search query itself may be such that the search results cannot be usefully personalized. For example, this is often the case when the user searches for a some type portal site, such as the home page of a commercial portal (e.g., Google.com, Yahoo.com, etc.), a news organization (e.g., CNN.com, or MSNBC.com), an organization (e.g., IEEE.com), or a government agency (e.g., the U.S. State Department). For these types of searches, the search engine identifies the portal aspect of in the search results (e.g., from the domain name), and then uses just the user profile, without personalization of the results, to select the advertisement. Thus, in this case, the user profile itself operates as the search profile.

From the foregoing, it should be appreciated that the present invention includes a general model of using a first set of algorithms to obtain and rank a first set of search results, and then using a second set of algorithms that analyzes the first set of results in order to rank a second set of search results, where the first and second results are from different data sets, and the first and second sets of algorithms are different from each other as well. Thus, in the above described embodiment, the first set of algorithms includes a search query algorithm to obtain the first set of search results from a general content corpus, and a personalization algorithm which ranks a first set of search results according to a user profile, and the second set of algorithm includes the content analysis module which analyzes the ranked search results to produce the search profile and the advertisement server which uses the search profile to search for and rank a set of advertisements from the advertisement database. The general method here is to use the ranked data resulting from one process to rank the data resulting from another process. This method may be employed in other applications, for example, where the first set of data is business financial data, and the second set of data is product information data.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “calculating” or “determining” or “identifying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

1. A computer implemented method for providing personalized advertisements in an online search engine, the method comprising:
selecting a set of documents responsive to a user query and a user profile containing user interest information; and
selecting an advertisement in response to a search profile derived from the set of documents.

2. The method of claim 1, wherein the user profile includes information derived from prior search queries provided by the user.

3. The method of claim 1, wherein the user profile includes keywords derived from prior search queries provided by the user.

4. The method of claim 1, wherein the user profile includes information derived from prior search results received by the user.

5. The method of claim 1, wherein the user profile includes keywords derived from documents included in prior search results received by the user.

6. The method of claim 1, wherein the user profile includes terms derived from anchor text of hyperlinks in documents included in prior search results received by the user.

7. The method of claim 1, wherein the user profile includes information derived from documents linked to documents included in prior search results received by the user.

8. The method of claim 1, wherein the user profile includes document format information of documents included in prior search results received by the user.

9. The method of claim 1, wherein the user profile includes information derived from user interactions with documents in prior search results received by the user.

10. The method of claim 1, wherein the user profile includes information describing an amount of time the user spent viewing a document included in prior search results received by the user.

11. The method of claim 1, wherein the user profile includes information describing an amount of scrolling activity in a document included in prior search results received by the user.

12. The method of claim 1, wherein the user profile includes information whether the user has printed a document included in prior search results received by the user.

13. The method of claim 1, wherein the user profile includes information whether the user has saved a document included in prior search results received by the user.

14. The method of claim 1, wherein the user profile includes information whether the user has bookmarked a document included in prior search results received by the user.

15. The method of claim 1, wherein the user profile is derived from previous web pages that the user has accessed.

16. The method of claim 1, wherein the user profile includes Universal Resource Locators derived from hyperlinks in documents included in prior search results received by the user.

17. The method of claim 1, wherein the user profile comprises a set of categories, each category associated with an weight indicating an importance of the category to the user.

18. The method of claim 1, wherein the user profile includes demographic information.

19. The method of claim 1, wherein the user profile includes psychographic information.

20. The method of claim 1, wherein the user profile includes geographic information of the user.

21. The method of claim 1, wherein the user profile indicates whether the user is a member of each of a plurality of groups.

22. The method of claim 1, wherein the user profile includes information derived from network domains associated with the user.

23. The method of claim 1, wherein the user profile is derived from the user's network address.

24. The method of claim 1, wherein the user profile includes information derived from network domains from which the user submitted the query.

25. The method of claim 1, wherein the user profile includes the types of network domains from which the user submitted the query.

26. The method of claim 1, wherein the user profile includes the keywords derived from websites associated with the network domains from which the user submitted the query.

27. The method of claim 1, wherein the user profile includes counts of network domains associated with prior search results received by the user.

28. The method of claim 1, wherein the user profile includes counts of URLs associated with prior search results received by the user.

29. The method of claim 1, wherein the user profile includes a list of keywords.

30. The method of claim 1, wherein the user profile is derived from preferences provided by the user.

31. The method of claim 1, wherein the search profile is derived from a subset of the documents.

32. The method of claim 1, wherein the set of documents form search results having a plurality of pages, and the search profile is derived from a subset of the documents appearing on a first page of the search results.

33. The method of claim 1, wherein the set of documents form search results having a plurality of pages, and the search profile is updated in response to the user accessing each page of the search results.

34. The method of claim 1, wherein the search profile is derived from the set of documents responsive to a current query, and a set of documents responsive to at least one previous query.

35. The method of claim 1 further comprising, responsive to the user accessing the advertisement, selecting another advertisement in response to the search profile.

36. The method of claim 1 further comprising, responsive to the query being for a portal, using the user profile to select an advertisement.

37. A computer implemented method for providing personalized advertisements in an online search engine, the method comprising:
receiving a query from a user;
receiving a user profile of the user, the user profile containing user interest information;
selecting a set of documents responsive to the query and the user profile;
deriving a search profile from the set of documents;
selecting an advertisement in response to the search profile; and
providing the selected advertisement and the set of documents to the user.

38. A computer implemented system that provides personalized advertisements in an online search engine, the system comprising:
a user profile database, containing a user profile of each of a plurality of users, each user profile containing user interest information;
a search engine, comprising a content database storing documents, and a search algorithm that receives a search query from a user and a user profile of the user from the user profile database, and selects from the content database a set of documents responsive to the query and to the user profile;
a content analysis module that derives a search profile from at least some of the selected set of documents;
an advertisement database that stores a plurality of advertisements; and
an advertisement selection module, coupled to the content analysis module to receive the search profile and coupled to the advertisement database to select an advertisement in response to the search profile.

39. A system for providing personalized advertisements in an online search engine, the system comprising:
a user profile database, containing a user profile of each of a plurality of users, each user profile containing user interest information;
a search means for receiving a search query from a user and receiving a user profile of the user from the user profile database, and selecting a set of documents responsive to the query and to the user profile;
a content analysis means for deriving a search profile from at least some of the selected set of documents;
an advertisement database for storing a plurality of advertisements; and
an advertisement selection means for selecting an advertisement from the advertisement database in response to the search profile.

40. A computer program product, stored on a computer accessible medium, for controlling a computer system to provide personalized advertisements in an online search engine by performing the method of:
receiving a query from a user;
receiving a user profile of the user, the user profile containing user interest information;
selecting a set of documents responsive to the query and the user profile;
deriving a search profile from the set of documents;
selecting an advertisement in response to the search profile; and
providing the selected advertisement and the set of documents to the user.

41. A computer implemented method of ranking results of a search query, the metod comprising:
using a first set of algorithms to obtain and rank a first set of search results from a first search query on a first data set, and
using a second set of algorithms to obtain and rank a second set of search results from a second search query on a second data set different from the first data set as a function of the ranking of the first set of results, wherein the first and second sets of algorithms are different from each other.

42. The method of claim 41, wherein using a second set of algorithms to obtain and rank a second set of search results from a second search query on a second data set different from the first data set as a function of the ranking of the first set of results comprises:
deriving a profile of the first set of search results; and
using the profile to rank the second set of search results.

43. The method of claim 41, wherein the first set of algorithms comprises:
a first search query algorithm that searches a first content database to obtain the first set of search results; and
a first ranking algorithm that ranks a first set of search results according to a profile.

44. The method of claim 41, wherein the second set of algorithms comprises:
a content analysis algorithm that analyzes the ranked first set of search results to produce a search profile; and
a second search query algorithm that searches a second content database using the search profile to obtain the second set of search results and that ranks the second set of search results.

45. A computer implemented method of ranking results of a search query, the metod comprising:
searching a first content database using a first search query algorithm to obtain a first set of search results;
ranking the first set of search results;
determining a profile of the first search results;
searching a second content database using a second search query algorithm to obtain a second set of search results; and
ranking the second set of search results using the profile.
